(19) United States
(12) Patent Application Publication
(10) Pub. No.: US 2017/0215426 A1
(43) Pub. Date: Aug. 3, 2017

(54) COMPOSITIONS FOR THE CONTROL OF ALGAE IN COMMERCIAL HORTICULTURE

(71) Applicant: KEMIN INDUSTRIES, INC., Des Moines, IA (US)

(72) Inventors: John Andrew GREAVES, Ankeny, IA (US); Norman Peter Cloud, Ames, IA (US)

(21) Appl. No.: 15/486,076

(22) Filed: Apr. 12, 2017

Related U.S. Application Data
(63) Continuation of application No. 14/133,041, filed on Dec. 18, 2013.
(60) Provisional application No. 61/738,621, filed on Dec. 18, 2012.

(51) Int. Cl. A01N 55/02; A01N 37/02

(52) U.S. Cl. CPC A01N 55/02; A01N 37/02

(57) ABSTRACT

New, highly effective and long-lasting algaecidal compositions of aqueous solutions of one or more organic acids and a source of metal ions.

This application is a continuation of U.S. patent application Ser. No. 14/133,041, filed Dec. 18, 2013, which claims priority to U.S. patent application Ser. No. 61/738,621, filed Dec. 18, 2012, and incorporated herein in its entirety by this reference.

### BACKGROUND OF THE INVENTION

The present invention relates generally to the control of algae in commercial horticulture and, more specifically, to the use of one or more organic acids either alone or in combination with one or more sources of metal ions to control algae in greenhouses.

Growers at commercial greenhouse facilities face the growth of algae as a perennial problem on floors, cooling pads, capillary matting and walls. Algae growing on floors create slippery conditions and are a recognized safety hazard in commercial greenhouses. Algae can also create a harbor for plant pathogens and insect pests such as shore flies and fungus gnats.

Growers also face the need to flush out irrigation water lines at the end of each growing cycle. Current products are based on just a few compounds which include quaternary ammonia molecules, oxidizing agents and inorganic acids (primarily sulfuric acid). According to the growers at least one facility, the quaternary ammonia based products and the oxidizing agents have varying degrees of efficacy and sulfuric acid can damage the concrete floors.

There is a need for an algaecide that is effective, long-lasting, non-polluting, and cost-effective.

### SUMMARY OF THE INVENTION

The invention consists of an aqueous composition of an aqueous solution of one or more organic acids and one or more sources of metal ions, such as salts of chromium, manganese, iron, cobalt, nickel, copper or zinc. In a preferred embodiment, a concentrated product contains propionic acid, acetic acid, benzoic acid, sorbic acid and copper carbonate. The concentrated product is diluted with water to obtain a composition suitable for spray application to a surface for control of algae. The preferred embodiment kills surface algae where it is applied and provides residual control for six weeks or longer post application.

The present invention is related to novel algaecides that may be mixed, in one step, with water just prior to application onto an algae-contaminated surface. The algaecidal mixture and resulting solution is less corrosive and less hazardous to work with compared to other algaecides on the market.

The present inventive algaecide mixture works well on concrete, pavement, tile, porcelain, vinyl, brick, stucco, fiberglass, and aluminum surfaces. These surfaces may be painted or unpainted. Generally, the algaecide mixture is applied to the surface until it is wet or until runoff is observed.

In a preferred application of a preferred embodiment of the algaecide mixture, five to ten ounces are diluted in a gallon of water (5-10 oz/g). Apply mixture using a sprayer to achieve small droplets for complete coverage, applying until runoff with one gallon treating 1000 square feet. One gallon of the preferred embodiment Quantavene™ 500 Liquid will treat 25,500 square feet of greenhouse space.

A purpose of the present invention is to provide an algaecide in aqueous solution having one or more organic acids either alone or in combination with a source of metal ions.

Another purpose of the present invention is to provide an algaecide wherein the organic acid comprises a carboxylic acid.

A further purpose of the present invention is to provide an algaecide wherein the organic acid is selected from the group consisting of propionic acid, acetic acid, benzoic acid, and sorbic acid.

Still another purpose of the present invention is to provide an algaecide wherein the source of metal ions comprises metal salts.

Yet a further purpose of the present invention is to provide an algaecide wherein the metal salts are selected from the group consisting of salts of chromium, manganese, iron, cobalt, nickel, copper and zinc.

### BRIEF DESCRIPTION OF THE FIGURES

FIG. 1 is a graph of the results of alternative non-copper formulations.

FIG. 2 is a photograph of the impact on algal growth on greenhouse floor 4 days after treatment with 2%, 1% and 0.5% Formula M+Cu and Formula K+Cu solutions along with controls.

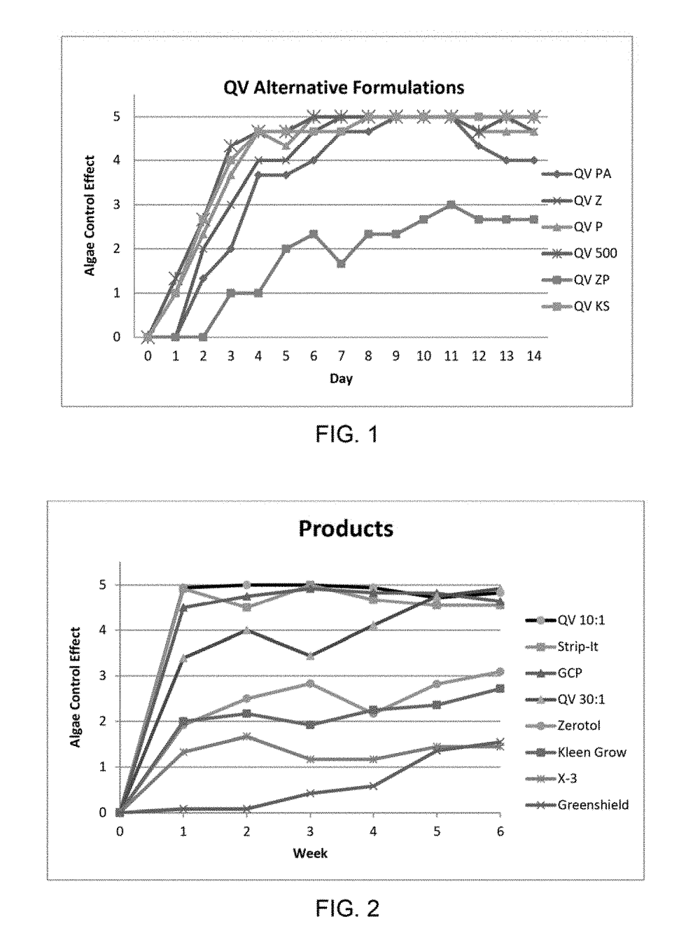

### DETAILED DESCRIPTION OF THE INVENTION

Typical application rates of algaecides in greenhouses in the U.S. are based on coverage or application per 1000 square feet of space. Many compounds are sold as concentrates that are diluted with water at the site, which is always available in greenhouses. Common dilutions are 5-10 liquid ounces per gallon allowing a gallon of concentrate to make 12-25 gallons of final solution to be made from a gallon of concentrate. Some products are granular and formulated to be applied directly to the greenhouse floor.

The term “algae” means eukaryotic microorganisms commonly found growing in high moisture environments with exposure to light, including sunlight. Non-limiting examples of algae include green algae.

The term “algaecide” means a composition that has the ability to reduce the number of algae microorganisms over a period of time. The term also applies to the ability to prevent the growth of algae microorganisms over a period of time. The term “metal ions” means the ionized state that the metals of metal salts assume in aqueous solutions of the appropriate pH. Non-limiting preferred metal ions of the present invention include ions of chromium, manganese, iron, cobalt, nickel, copper and zinc.

The term “organic acid” means an organic compound with acidic properties and includes carboxylic acids, whose acidity is associated with their carboxyl group. Non-limiting examples of organic acids include acetic acid, benzoic, butyric acid, citric acid, formic acid, fumaric acid, gallic acid, propionic acid, sorbic acid, succinic acid, tannic acid and tartaric acid.

Where ranges are used in this disclosure, the end points only of the ranges are stated so as to avoid having to set our and length and describe each and every value included in the range. Any appropriate intermediate value and range between the recited endpoints can be selected. By way of example, if a range of between 0.1 and 1.0 is recited, all intermediate values (e.g., 0.2, 0.3. 6.3, 0.815 and so forth) are included as are all intermediate ranges (e.g., 0.2-0.5, 0.54-0.913, and so forth).

Preferred organic acids include: acetic acid used within the range of from 0.0% to 50%, preferably between 1% and 20%, and more preferably between 5% and 15% of the compositions of the present invention; benzoic acid used within the range of from 0.0% to 10%, preferably between 0.1% and 5%, and more preferably between 0.5% and 3% of the compositions of the present invention; propionic acid used within the range of from 0.0% to 100%, preferably between 25% and 90%, and more preferably between 50% and 80% of the compositions of the present invention; and sorbic acid used within the range of from 0.0% to 5%, preferably between 0.01% and 1%, and more preferably between 0.05% and 0.2% of the compositions of the present invention.

### EXAMPLE 1

Initial tests were done on (1) a mixture of organic acids (greater than 99% propionic acid) with and without copper propionate and diluted with soft water (Formula M), and on (2) a mixture of organic acids (greater than 86% propionic acid and greater than 11% acetic acid) with and without copper propionate and diluted with soft water (Formula K). Both products were tested for initial efficacy on algae growing on a local greenhouse floor. All results are based on visual assessment of efficacy.

### Materials and Methods

A source of copper propionate was created by dissolving 55.0 wt. % copper carbonate in 73.7 wt. % propionic acid (hereinafter Cu Base). Solid to liquid formulations were weighed using an AND GR-200 balance, mixed using magnetic stir bars and a Fisher Isotemp stir plate. Liquid to liquid dilutions were made using glass graduated cylinders.

Initial 2% elemental copper solutions were attempted by dissolving 6.8 g of Cu Base into 93.2 g of Formula K and Formula M. It was observed that Cu Base dissolved more readily in Formula M than in Formula K with continuous stirring at ambient temperature for 24 hrs. After 24 hr, two dilutions each of the 2% copper Formula M and 2% copper Formula K solutions were created to make 1% and 0.5% elemental copper solutions. All 6 solutions were made in brown bottles. The 6 copper solutions, 2%, 1% & 0.5% copper in Formula M 2%, 1% and 0.5% copper in Formula K, were then diluted 25:1 in water for immediate testing on greenhouse floor (Table 1).

TABLE 1
Initial copper based algaecides for use on greenhouse floor

| | Formula M + Cu | | | Formula K + Cu solutions | | |
|---|---|---|---|---|---|---|
| | solutions (w/w) | | | (w/w) | | |
| | 2% | 1% | 0.5% | 2% | 1% | 0.5% |
| Formula M | 93.2 g | 96.6 g | 98.3 g | | | |
| Formula K | | | | 93.2 g | 96.6 g | 98.3 g |
| CU Base | 6.8 g | 3.4 g | 1.7 g | 6.8 g | 3.4 g | 1.7 g |
| Water dilution | 25:1 | 25:1 | 25:1 | 25:1 | 25:1 | 25:1 |
| applied in | | | | | | |
| Greenhouse | | | | | | |
| (v/v) | | | | | | |

Areas in the concrete floored greenhouse containing obvious algal growth were identified, typically underneath benches of potted plants. Eight (8) areas were circled using a disposable plastic Petri plate as template and Sharpie pen. Using disposable plastic pipettes the areas inside the circles were treated with the final 25:1 water dilutions of Formula M solutions, Formula K solutions, tap water control or left untreated. The area in the circle was completely wetted and then allowed to dry. Only one replicate of each treatment was done due to space and lack of evenly coated algae-contaminated floor.

Observations that there was sediment or precipitate in the initial Formula K+Cu solutions and the final Formula M+Cu water dilutions 24 hrs after mixing suggested a second round of formula construction. Three solutions, 2%, 0.5% and 0.174% elemental copper, using Formula K were attempted in clear glass to observe solubility. In these formulas Formula K was kept at 80% (by weight) of the solution with the Cu Base and water amounts adjusted to obtain final % copper, Table 2.

TABLE 2
Second copper based algaecides made by dissolving Cu Base into
80% Formula K and then diluting in water at 5 ounces per gallon
for use in greenhouse

| | 2% | 0.5% | 0.174% |
|---|---|---|---|
| Formula K | 80 g | 80 g | 80 g |
| Water | 13.2 g | 18.3 g | 19.4 g |
| Cu Base | 6.8 g | 1.7 g | 0.6 g |
| Water dilution applied to Greenhouse (v:v) | 25:1 | 25:1 | 25:1 |

### Results

Cu Base readily dissolved into Formula M in the range of 0.5% to 2.0% w/w to make pale blue solutions. These solutions appeared to be stable for at least 24 hrs without stirring. When used at 25:1 dilutions in water, the three Formula M+Cu solutions were stable enough to apply to the floor. After standing for a few hours, however, all the Formula M+Cu water solutions formed dense, wispy precipitates that settled to the bottom of the container.

Cu Base was not readily soluble in Formula K alone. With addition of the Cu Base, the solution quickly turned a very dark blue, but particles could be seen swirling during stirring. This was very obvious at 6.8% Cu Base (2% copper) concentration. After 24 hrs, it was difficult to determine if all solids were in solution due to the dark blue color. The 25:1 water dilutions appeared stable, similar to the Formula M+Cu dilutions, when made and applied to the floor. Upon standing the 2%, 1% and 0.5% Formula K+Cu liquids all developed visible granular sediment within a few hours but no sediment or precipitate was observed in the 25:1 final water dilutions made from those solutions.

All Formula M+Cu and Formula K+Cu floor treatments visually reduced algal growth over 4 days. There appeared to be some dose response effect in both Formula M+Cu and Formula K+Cu treatments with higher copper formulations.

Formula K+Cu treatments appeared to be more effective than adjacent Formula M+Cu treatments particularly when comparing the 0.5% copper treatments. Based on visual observations, the Formula K+Cu 0.5% treatment appeared to clear algae nearly as well as the 2% Formula M+Cu treatment. Copper treated areas had noticeably less algae or remained clear of algae for weeks after treatment. It is important to note that a 25:1 dilution of a 2% copper propionate solution (20,000 ppm) is 800 ppm copper in water and 25:1 dilution of 0.5% (5000 ppm) results in 200 ppm copper in the final water solution.

The addition of water to Formula K improved the solubility of Cu Base. A 2% copper solution could still not be made; even though most of the base dissolved within a few minutes, there was still un-dissolved material after 1 hour. Keeping Formula K at 80% of solution weight and adding 18.3% or 19.4% water allowed 0.5% and 0.174% copper solution to be dissolved in under 30 minutes. These solutions were dark blue and remained stable for >24 hrs after mixing. The 25:1 water dilutions made from these solutions were also stable for >24 hours after mixing. Treatment of greenhouse floor with the 80% Formula K plus 0.5% and 0.174% copper solutions resulted in algal reduction similar to initial Formula K+Cu treatments.

### Conclusions

The use of Cu Base dissolved in propionic acid-based liquids negatively impacted algal growth at all treatment levels. While Cu Base readily dissolved in Formula M, all typical water dilutions of those solutions were unstable. In contrast any copper dissolved in Formula K appeared to be very stable when further diluted with water. The solubility of Cu Base appeared to be very low, below 0.5%, in Formula K alone.

Formula M contains greater than 28% water while Formula K has only around 9%. This seemed to indicate that addition of water to Formula K might increase the solubility of the Cu Base. Addition of water to Formula K to around 27% prior to addition of Cu Base greatly improved solubility at 0.5% copper and below. Water solubility is likely an important characteristic for activity since greenhouse surfaces go through multiple wetting and drying cycles.

As stated in the results section, the concentration of elemental copper in the final water dilutions ranged from a high of 800 ppm in the 2% solutions to 70 ppm in the 0.174% Formula K+Cu solution when used at 25:1 dilution. The testing did not indicate a large difference between these rates, with all treatments providing some residual control. It would be expected that if the propionic acid alone was providing all the efficacy, frequent wetting cycles would wash it from the system in only a few days, allowing algae regrowth. What was observed instead was residual control preventing algae regrowth in treated areas, even when completely surrounded by untreated algae. Our hypothesis is that copper propionate stays embedded as a barrier in the surface of the concrete preventing recolonization.

### EXAMPLE 2

Algal growth in commercial greenhouses is reported to be a serious problem with limited effective products on the market. Solutions often involve frequent cleaning with mild detergent-type compounds and physical abrasion to remove the algal mats. The copper based algaecides have had mixed reviews and few offer residual control to prevent algal regrowth in wet areas. There is a need for cost effective algaecides that can be widely applied in water to maintain clean surfaces. The combination of relatively low residual copper in propionic salt form appears to have very good efficacy against algae and is a unique approach to keeping greenhouse surfaces algae free for extended periods. The 0.174% Formula K+Cu of Example 1 solution was further tested at two commercial greenhouses.

### Commercial Greenhouse A

The 0.174% Formula K+Cu solution was used at a commercial greenhouse (Greenhouse A) for larger scale testing. The 0.174% Formula K+Cu solution was diluted to 16:1; 32:1 and 64:1 (water/ Formula K+Cu) and applied directly to the greenhouse floor in areas affected by algal growth using a standard liquid spray application system until fully wetted. Within 2 weeks, algae in affected areas had been eliminated at the 16:1 and 32:1 application rates. Complete control of algae was not achieved at the 64:1 application rate.

The residual activity of the diluted 0.174% Formula K+Cu solution resulted in little to no algal regrowth in the sprayed areas for over a month; despite the floors being wet.

### Commercial Greenhouse B

The 0.174% Formula K+Cu solution was used at a commercial greenhouse (Greenhouse A) for larger scale testing. During a tour of the facility, it was clear that algae were everywhere on the floors, cooling pads and at the base of structural uprights where water condenses from the roof and drains to the floor.

### Materials and Methods

Preparation of Experimental Area. At a designated test site in Greenhouse B, seven five-foot sections of algae-caked floor were measured and marked off with white spray paint, with a buffer zone between the sections to assure isolation of the individual sections. The sections were designated Sections 1-7, respectively.

Application of Algaecide. Commercial Greenhouse B uses both water from a municipal supply and water from a nearby pond. The 0.174% Formula K+Cu solution liquid was applied to the seven sections using the following application rates:

Section 1: Straight (undiluted) Exp. 0.174% Formula K+Cu solution;

Section 2: 10 parts pond water to 1 part Exp. 0.174% Formula K+Cu solution;

Section 3: 10 parts municipal water to 1 part Exp. 0.174% Formula K+Cu solution;

Section 4: 20 parts pond water to 1 part Exp. 0.174% Formula K+Cu solution;

Section 5: 20 parts municipal water to 1 part Exp. 0.174% Formula K+Cu solution;

Section 6: 30 parts pond water to 1 part Exp. 0.174% Formula K+Cu solution;

Section 7: Pond water.

Before each application, the concrete was allowed to dry completely and photographs of each section were taken. Applications were made on day 1, day 8, and day 15. The test compositions were sprayed on the test surfaces until they were fully wetted. The spray applicator was rinsed with pond water and drained thoroughly between applications to ensure that no cross-contamination between the different treatments occurred.

Between applications, the drip tubes on the floor sections ran at all hours to create ideal conditions for algae growth. During the daytime, in addition to the drip tubes running, a boom over the test area passed every 20 minutes and sprayed the floor with pond water to even out the moisture.

### Results

On day 8, there was a noticeable difference between the treated and control sections. By day 15, all of the trial sections (1-6) were completely clean, leaving only gray stains from the dead algae colonies on the concrete. On day 29, two weeks after the last application, there was no negative change in algae reduction and prevention from the previous observations.

### Conclusions

There are no commercially available organic acid products+metal ions such as copper for use as algaecides in commercial greenhouse environments. Current products include quaternary ammonia compounds, oxidizing agents and weak inorganic acids. The use of organic acids, particularly efficacious antifungal and anti-bacterial acids such as propionic, acetic and benzoic, is novel for this application, especially co-formulated with metal ions such as copper.

### EXAMPLE 3

### Materials and Methods

Raw materials. All materials used in the production of the experimental product (Quantavene™ 500) were sourced from Kemin Industries, Inc. (Des Moines, Iowa). The composition of comprised 69% propionic acid, 10% acetic acid, 1% benzoic acid, 0.1% sorbic acid (together comprising the “Organic Acid Fraction”), 0.6% Cu Base and 19.4% water. Additional ingredients may be used including preservatives, pH adjusters, colorants, fragrances and the like.

Treatment Area: Greenhouse B had a designated test site in the greenhouse, famoulsy called the “algae pit”. Seven five-foot sections of algae-caked floor were measured and marked off with white spray-paint, with a buffer zone between the sections where pure Quantavene™ 500, and plain pond water would be applied.

Applications: One gallon of each of the agreed ratios of water to Quantavene™ 500 were mixed and applied to runoff in their designated sections: 10:1 with pond water in section #2, 10:1 with city water in section #3, 20:1 with pond water in section #4, 20:1 with city water in section #5, 30:1 with pond water in section #6. Pure Quantavene™ 500 was applied to section #1, and plain pond water to #7 to establish a control. Before each application, the concrete was allowed to dry completely, and pictures of each section were taken. Quantavene applications were made on the 1st, 9th, and 15th of the month at approximately 2:00 pm. The backpack sprayer was rinsed with pond water and drained thoroughly between applications, to ensure that no cross-contamination between the different treatments occurred. Between applications, the drip tubes on the floor ran at all hours in order to create ideal conditions for algae growth. During the daytime, in addition to the drip tubes running, the boom over the test area passed every twenty minutes and sprayed the floor with pond water to even out the moisture.

### Results

Greenhouse B trial results. The hypothesis about the effectiveness of the Quantavene™ 500 algaecide being reduced by mixing it with pond water was proven false with confidence. There were no observable differences. Aside from section #1, which received the undiluted Quantavene™ 500, the various dilutions all showed rapid reduction and elimination of all algae growth. In addition, the difference in effectiveness between the pure Quantavene™ 500 and the highest dilution ratio (30:1) was negligible.

### Discussion

The Quantavene™ 500 product works well for Greenhouse B's system. Since Quantavene™ 500 is a liquid, it could be applied through either a backpack sprayer, through a portable injector, or a sprayer for treating larger areas.

### EXAMPLE 4

The purpose of this experiment was to evaluate non-copper based formulations of Quantavene™ 500. There are markets in both the US and around the world, such as California and Western Europe that have very strict regulations in place for the use of copper. As a result, an experiment was designed to look at several different formulations of Quantavene™ 500. These formulations included Quantavene™ 500, Quantavene 500 P (Cu Base+propionic acid alone), Quantavene Z (zinc propionate replacing copper propionate), Quantavene ZP (zinc propionate replacing copper propionate+propionic acid alone), Quantavene PA (propionic acid only), Quantavene CU (Cu Base+water), Quantavene ZN (zinc propionate replacing copper propionate+water), and Quantavene OAF (Quantavene™ 500 without Cu Base).

### Materials and Methods

Formulations. All formulations of Quantavene™ 500 are summarized in Table 3.

TABLE 3
Raw material identification.

| | Label Name | | | | | | | |
|---|---|---|---|---|---|---|---|---|
| | | | | | | Quantavene | Quantavene | Quantavene |
| | Quantavene | Quantavene | | Quantavene | Quantavene | CU | ZN | OAF |
| | 500 | 500 P | Quantavene Z | ZP | PA | CuBase + | ZnBase + | OAF¹ + |
| Description | Cu + OAF¹ | Cu + PA² | Zn + OAF¹ | Zn + PA² | PA² + Water | Water | Water | Water |
| OAF¹ | 800 | | 800 | | | | | 800 |
| (g) | | | | | | | | |
| Propionic | | 650 | | 650 | 650 | | | |
| Acid | | | | | | | | |
| (g) | | | | | | | | |
| Cu | 6 | 6 | | | | 6 | | |
| Base | | | | | | | | |
| Dry (g) | | | | | | | | |
| Zn | | | 5.33 | 5.33 | | | 5.3 | |
| Propionate | | | | | | | | |
| Base | | | | | | | | |
| (g) | | | | | | | | |
| RO | 194 | 344 | 194.66 | 344.66 | 350 | 944 | 994.7 | 200 |
| Water | | | | | | | | |
| (g) | | | | | | | | |
| Total | 1000 | 1000 | 1000 | 1000 | 1000 | 1000 | 1000 | 1000 |
| Batch | | | | | | | | |
| (g) | | | | | | | | |

¹OAF is the Organic Acid Fraction
²PA is propionic acid

Quantavene Formulations. Eight different Quatavene formulations were tested. All products were diluted at 30:1 (water to Quantavene) per gallon of water.

Treatment Zones. Greenhouse C provided us with several 40 ft walkways to perform our Quantavene™ 500 testing. In this case, algae growth was not uniform so the treatment zones had to be modified. 4.5 inch circles were used for each formulation due to spacing availability. Three separate treatment zones in total were created, with each zone containing the different Quantavene formulations and a control thereby providing 3 replicates. All treatments were randomized.

Application and Scoring. Application of each product was made on Day 1. The circles were applied with the test formulations until thouroughly wetted. Observations were recorded daily for 14 days and each application area was visually scored using a scoring system as follows: 1=no change, 2=slight discoloration, 3=moderate discoloration, 4=severe discoloration, 5=complete death.

### Results

The results of this study show that there are several different formulations that are effective at killing algae. Quantavene™ 500, Quantavene 500 P, Quantavene, Quantavene PA, and Quantavene OAF all achieved scores of 4 or higher by the end of Day 14 (FIG. 2). Quantavene ZP was only mildly effective, with little algae kill off seen. Quantavene ZN and Quantavene CU did not have any killing effect on the algae over the course of 14 days.

### Discussion

Quantavene™ 500 and several other Quantavene formulations were found to be effective at killing and inhibiting the re-growth of algae. Quantavene™ 500, Quantavene P, Quantavene OAF, and Quantavene Z were found to be significantly different compared to the other formulations (P<0.05). We can see that the Quantavene formulations with either copper or zinc mixed with the Organic Acid Fraction were equally effective. An effect on algae with the Organic Acid Fraction applied alone and propionic acid applied alone, however no data was taken beyond 14 days on these formulations. Our hypothesis was that organic acids by themselves would not provide the same amount of residual as an organic acid and metal combination. Another key observation was that the copper or zinc by itself did not provide an activity. This goes to show that is important to have an acid present in the formulation, possibly to help break down the algal cells to allow for the influx of metal ions.

### EXAMPLE 5

There are four key decision criteria that greenhouse growers use to evaluate algaecides. Those criteria are as follows: provides good efficacy, long duration of effect, does not adversely affect the crop or its water system, and is safe for employees to use. The purpose of this experiment was to evaluate the first and second criteria for Quantavene™ 500 and several competitor algaecide products on the market. The competitor products that are on the market consist of several different chemistries. Those chemistries include quaternary ammonium chloride salts (Green-Shield, KleenGrow), hydrogen dioxide/peroxyacetic acid (Zerotol, Xeroton), sodium carbonate peroxyhydrate (GreenClean Pro), and sulfuric acid based products (Strip-IT). The main issue that growers have with both the quaternary ammonium salts and the hydrogen dioxide/peroxyacetic acid products is that they leave no residual activity behind, thus allowing algae regrowth in a short period of time. The sulfuric acid based products also have their drawbacks in that they are extremely corrosive and tend to only be used at the end of a growing season when cleaning out a production house.

### Materials and Methods

Algaecide products. Six different competitor products were selected and can be seen in

Table 2. The algaecides that were selected were considered to be the top algaecide products available on the market today. All products were dosed per label recommendations for the treatment of hard surfaces. The dilution rates that were selected for Quantavene™ 500 were 10:1, 30:1, 60:1. 100:1 (water to Quantavene™ 500) to coincide with previous testing of Quantavene™ 500 applied directly to contaminated surfaces; the Quantavene compositions were applied until runoff was observed.

TABLE 4
Algaecide Products Tested

| | | Volume |
|---|---|---|
| | Dilution | per gallon |
| Product (Company) | Rate | (oz.) |
| Zerotol (BioSafe) | 50:1 | 2.5 |
| Green-Shield (BASF) | 250:1 | .5 |
| Strip-IT (Pace 49) | 30:1 | 4.3 |
| KleenGrow (Pace 49) | 50:1 | 2.5 |
| Xeroton (Phyton) | 250:1 | .5 |
| GreenClean Pro | NA | NA |
| (BioSafe)* | | |
| Quantavene ™ 500 | 10:1 | 12.8 |
| Quantavene ™ 500 | 30:1 | 4.3 |
| Quantavene ™ 500 | 60:1 | 2.13 |
| Quantavene ™ 500 | 100:1 | 1.3 |

*GreenClean Pro is a granular product. 1 lb per 1000 sqft

Treatment Zones. Greenhouse C provided us with several 40 ft walkways to perform our Quantavene™ 500 testing. Algae were allowed to grow on each of these walkways until complete coverage was obtained. Four separate treatment zones were created, one zone for each of the four Quantavene™ 500 dilutions. Each zone contained three identical grids to allow for 3 replicates. Within each grid there were 6 sections (40 inches tall by 6 inches wide) and within the section there were 3 application areas (control, competitor product, and Quantavene™ 500). All treatments were randomized.

Application and Scoring. Application of each product was made on Day 1 and Day 14. Observations were recorded daily and each application area was visually scored using a scoring system as follows: 1=no change, 2=slight discoloration, 3=moderate discoloration, 4=severe discoloration, 5=complete death.

### Results

The results of this study show that both Quantavene™ 500 at 10:1 and 30:1 as well as Strip-IT performed better and those results were statistically significant (p<0.05) compared to the other products tested. All three of these products were effective by the end of week 1 and maintained their effectiveness over the course of six weeks. The quaternary ammonium salt products (Greenshield, KleenGrow) provided the least amount of algae control of all the products tested. These results were consistent with the feedback that was received from industry experts and greenhouse growers. These products have only been found to be effective when overdosed or combined with another product such as Strip-IT. The oxidizer products (GreenClean Pro, Xeroton, Zerotol) provided slightly better activity against algae. The GreenClean Pro product, which is a granular product, was believed to have been overdosed given the space that was treated. This may have resulted in better performance than was to be expected.

### Discussion

Quantavene™ 500 and several other competitor algaecide products were measured for algae control over the course 6 weeks. Results indicate that Quantavene™ 500 applied at both a 10:1 and 30:1 application rate are effective at killing algae and preventing re-growth for 6 weeks. Quantavene™ 500 also proved to be superior to other competitor products on the market. Strip-IT, a sulfuric acid based product, proved to be equally as effective at killing algae however this product is very corrosive and is not recommended for routine maintenance of a greenhouse facility. This product is to be used at the end of a growing cycle when the production house is being cleared out. In conclusion, Quantavene™ 500 has shown to be an effective product for algae control and it can outperform several of the competitor algaecide products that are being sold today.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art who have the disclosure before them will be able to make modifications and variations therein without departing from the scope of the invention.

We claim:

1. An algaecide, comprising: in aqueous solution one or more organic acids either alone or in combination with a source of metal ions.

2. The algaecide of claim 1, wherein the organic acid comprises a carboxylic acid.

3. The algaecide of claim 1, wherein the organic acid is selected from the group consisting of propionic acid, acetic acid, benzoic acid, and sorbic acid.

4. The algaecide of claim 1, wherein the source of metal ions comprises metal salts.

5. The algaecide of claim 4, wherein the metal salts are selected from the group consisting of salts of chromium, manganese, iron, cobalt, nickel, copper and zinc.
